(19) United States
(12) Patent Application Publication
(10) Pub. No.: US 2024/0353917 A1
(43) Pub. Date: Oct. 24, 2024

(54) HUMAN BEHAVIOR RECOGNITION SYSTEM BASED ON IOT POSITIONING AND WEARABLE DEVICES

(71) Applicant: JUNG-TANG HUANG, Taipei (TW)

(72) Inventor: Jung-Tang Huang, Taipei (TW)

(21) Appl. No.: 18/137,219

(22) Filed: Apr. 20, 2023

(51) Int. Cl. G06F 3/01; G06F 1/16; G16Y 20/40; G16Y 40/10

(52) U.S. Cl. CPC G06F 3/011; G06F 1/163; G06F 1/1686; G06F 1/1694; G16Y 20/40; G16Y 40/10

(57) ABSTRACT

A human behavior recognition system includes a wearable device and an IOT system; the wearable device has a built-in 9-axis inertial motion unit (IMU) and an altimeter, a wireless communication module, and a microprocessor; the user wears the wearable device which is fixedly attached to the chest to judge the user's actions including standing, sitting, lying, walking, running, roaming, falling, etc. The nodes or beacons of the IOT positioning system are installed in various areas of the living space. The packet information broadcast to the wearable device includes: the latitude and longitude of the preset installation location when the node or tag is installed, the area name where the installation location is located, and the name of each key furniture in the preset area, the corresponding geomagnetic fingerprint and RSSI fingerprint, corresponding latitude and longitude, and the user's orientation when using the key furniture; in this way, the wearable device can integrate the user's actions with the information of the broadcast packet, and directly calculate the user's behavior through the state machine in the wearable device to obtain the user's accurate behavior recognition. And further the system may add a physiological and biochemical signal detection bracelet for the user to synchronously detect the physiological and biochemical signals during the behavior, and then upload it to the server through the IOT system, then the server combines with user's habit, and conduct accurate behavioral analysis.

### BACKGROUND OF THE INVENTION

### 1. Field of the Invention

The present invention relates to the field of human behavior recognition technology, and in particular, to a human behavior recognition system based on IoT positioning and wearable devices.

### 2. Description of Related Art

Traditional methods for recognizing daily activities of household residents usually require the use of cameras or additional sensors such as microwave or force sensing pads and mats, magnetic switches, or other proximity sensors to detect interactions between the user and various facilities in the environment. However, this requires the installation of many sensors, making maintenance difficult and adding significant cost. The use of cameras may also violate privacy and is often not acceptable to people. There are also blind spots that cannot be captured, and the processing time and resources required for image processing are high. Although the use of microwaves does not violate privacy, there are still blind spots, and it is difficult to distinguish between users when there are multiple people or pets in the environment.

In addition, wearable devices such as wristbands and watches have been widely used, but they can only detect physiological signals and activity levels, or at most can simply recognize human activities such as standing, sitting, lying down, walking, roaming, and falling. However, there are often misjudgments, and it is impossible to determine behaviors such as eating, drinking, brushing teeth, going to the toilet, taking a shower, watching TV, or applying makeup. Moreover, behavior recognition needs to be customized or personalized based on the location. Furthermore, engaging in different activities may result in different physiological and biochemical signals. For example, when the heart rate exceeds 90 while sitting still, it may indicate extreme nervousness, or when the heart rate is too high during sleep, it may indicate poor sleep quality or a cardiovascular disease.

TW 1671740 (published 202001892) discloses an indoor positioning system and method based on the combination of geomagnetic signals and computer vision. The current position and walking trajectory are detected through the inertial measurement unit to combine the computer vision coordinates and the geomagnetic signal coordinates to form a computer vision map and a geomagnetic data map. Its disadvantage is that the user needs to wear a camera and perform a large amount of computation in the cloud.

Although the conventional indoor positioning method can roughly locate users indoors, it is not easy to distinguish the distance between facilities in the environment, such as the distance between the toilet and the washbasin in the bathroom, and it may require the use of UWB for three-point positioning, which will increase the installation cost. Even if the user is already located on the toilet, it is impossible to know the user's orientation, whether facing the toilet or facing away from it, standing or sitting, and their behavior is different.

Therefore, there is a need for a new invention that allows the user's wearable device to directly determine their behavior, similar to using a camera to capture motion images and using AI to recognize their behavior. This invention utilizes pre-set spatial calibration, including the usage of every furniture item in each area of the living space, such as orientation, motion or body posture when in use, and combining the furniture's function in the space. When the user's specific furniture usage is confirmed, the behavior can be directly located, rather than relying on learning technology that requires spatial positioning, followed by motion detection, cloud conversion, and complex AI learning, to know its rough behavior.

In summary, currently there is no technology that can effectively and directly detect human behavior while also ensuring privacy rights. Therefore, it is difficult to obtain accurate information regarding people's daily routines and the physiological and biochemical signals that occur during these activities.

### SUMMARY OF THE INVENTION

The purpose of this invention is to propose a system for human behavior recognition, which includes an IoT system, a wearable device, and a server. The wearable device is equipped with a nine-axis inertial measurement unit (IMU) and an altimeter, and is preferably worn on the chest to determine the user's activities, such as standing, sitting, lying down, walking, roaming, falling, etc. The packets broadcast by the nodes or beacons of the IoT system not only provide the latitude, longitude, and altitude of the installation location, but also the name of the room where the device is located, such as the kitchen, bedroom, bathroom, toilet, balcony, stairwell, basement, garage, etc. Additionally, the packets provide the magnetic fingerprint, received signal strength indicator (RSSI) fingerprint, latitude and longitude, and user orientation of several key pieces of furniture in the room where the device is located. By using finite state machines and fusion calculations, the wearable device can obtain the user's behavior recognition, which is further uploaded to the server via the IoT system. The location and time period of these activities, as well as the user's habits, can be accurately identified through the system, resulting in precise behavior recognition.

Another purpose of this invention is to propose a system for human behavior recognition, which is based on the specific functions of each fixed piece of furniture in an indoor environment (such as a toilet, sink, bathtub or shower, bed, dining table and chairs, etc.). When the user is near the furniture and performs various actions, the system can accurately determine specific behaviors. For example, if the user is near and facing away from the toilet and performs a sitting motion, it can be inferred that the user is urinating or defecating. If the user is standing at the sink, facing it, and making small movements with his hands near their mouth after meals, the system can determine that the user is brushing his teeth.

In addition to the wearable device that hangs on the chest (also known as an amulet), the wearable device of the present invention can further add a physiological wristband to synchronously detect the level and changes of the user's physiological signals when engaging in daily activities. The physiological wristband can measure heart rate, electrocardiogram, HRV, blood oxygen, blood pressure, respiration, body surface impedance, etc., and then estimate emotions, fatigue, and stress levels.

In some embodiments, the amulet and physiological wristband can be worn separately, with the amulet fixed to the chest and attached to a necklace. It can be worn for a long time, easy to develop a habit, not easily placed at will, not forgotten, and easily accepted. Especially if it can detect falls and prevent falls, and has an emergency call button for help. Therefore, daily activities and body posture can be detected through this wearable device fixed on the chest. The physiological wristband uses Bluetooth broadcasting, and the amulet has Bluetooth 5.0 or higher transmission capability and can use Coded PHY to transmit long packets. The amulet can receive the broadcast packets from the physiological wristband, then integrate the body posture and location fingerprints obtained by the amulet into one packet and upload it to the router or gateway, and then to the server or cloud.

In some embodiments, the amulet can detect the body posture and can also be used to interact with the physiological wristband to detect whether smokers are smoking. This method is to wear the physiological wristband on the hand used to smoke and broadcast the physiological signal to the amulet for a fixed period of time, such as 1-2 seconds. When not smoking, the Bluetooth communication RSSI strength between the physiological wristband and the amulet is slightly weaker due to the distance between them. However, when smoking, the distance between the physiological wristband and the amulet is close, and the RSSI strength of the Bluetooth communication is relatively stronger. By detecting the periodic fluctuations of the broadcast packets received by the amulet from the physiological wristband, which correspond to the periods of bringing the cigarette close to and away from the mouth, it can be determined whether the user is smoking. Record the smoking behavior, time, and frequency every day to understand the user's addiction and compare their physiological data before, during, and after smoking to identify the cause of smoking and provide strategies to quit smoking.

In some embodiments, the amulet of the present invention further includes a mini camera, a recording device, or both. The camera can be triggered by the action judgment or position judgment of the amulet's IMU, or by a button on the wearable device, or by Bluetooth from an external device, or by a physiological wristband worn on the dominant hand approaching the mouth, causing the Bluetooth communication RSSI strength between the wristband and the amulet to increase, triggering the camera to take a photo. One important application is to record eating, taking medication, drinking water, drinking beverages or alcohol, smoking, and other behaviors and contents related to health. For users who eat and drink casually and anytime, a camera attached to the chest can effectively record every eating and drinking behavior and its content.

In some embodiments, in addition to the amulet attached to the chest, the wearable device of the present invention can further add a Bluetooth mini camera, a recording device, or both, which can be a video or audio recorder, or built into glasses. The Bluetooth camera can be triggered by the action judgment or position judgment of the amulet's IMU, or by a button on the amulet, or by a physiological wristband worn on the dominant hand approaching the mouth, causing the Bluetooth communication RSSI strength between the wristband and the amulet to increase, triggering the camera to take a photo. Alternatively, an approach sensor such as an infrared distance sensor can be added to the wearable device to trigger the camera to take a photo when the dominant hand approaches the mouth and comes close to the wearable device on the chest.

From past literature, it is known that wearable devices must be able to accurately detect users' movements such as standing, sitting, lying down, walking, roaming, falling, running, etc. The best wearing position is on the chest, and it needs to be fixed on the chest and cannot move or shake randomly. However, the common technique used to fix the device on the chest is by using a chest strap, but this method is difficult to wear for 24 hours. In order to be able to fully detect and monitor users' behavior at all times, especially to prevent and detect falls, there must be no downtime. There are also technologies that use necklace-style wearable devices, but this method also has disadvantages because the hanging wearable device may move and its posture cannot synchronize with the user's upper body posture, making it difficult to accurately reflect the body's movements and postures. For example, standing and sitting may not be effectively distinguished, or when the upper body bends forward, the hanging wearable device's angle in the 3-axis may not be different from not bending, making it difficult to recognize whether the user is bending. When running, the necklace-style wearable device may sway randomly, making it difficult to accurately recognize the number of steps taken.

The requirement for wearing the amulet on the user's body is to be fixed on the trunk, with priority given to the chest. In order to ensure that it can be worn for 24 hours even in summer when the temperature is high, the clothing is minimal, or when bathing with no clothes or only wearing swim trunks, this invention proposes an effective method for fixing it to the wearer's chest skin, as follows:
Step 1: Use a biomimetic non-gel self-adhesive structure, such as a gecko foot or octopus suction cup, as the back adhesive film of the amulet. It can effectively grip the wearer's chest skin while retaining enough breathability, easy to remove, and will not cause skin damage. It can be removed and re-stuck to the chest skin at any time. This biomimetic non-gel self-adhesive structure can maintain its viscosity for at least three to fourteen days, even when bathing, so that the wearer can be protected and easily detect falls or even unstable standing in the bathroom with no downtime.

Step 2: Furthermore, connect the amulet with a neck strap, so that when the amulet is removed or replaced, it can naturally hang and be consistently fixed in the chest position. It can also avoid the amulet from falling off due to external impact and detachment from the skin only relying on step 1. If the wearer wears more clothes, hanging it on the neck is less likely to slide, and the amulet can be fixed to the clothes using Velcro.

The method of fixing the amulet according to the present invention can bring many benefits. Firstly, the criteria for judging various actions remain unchanged because the amulet is fixedly attached to the wearer's chest and does not suffer from the problems of swinging and shaking associated with conventional wearable devices. The posture obtained from the IMU and altimeter measurements on the amulet completely synchronizes with the upper body posture of the user and can reflect the user's movements and postures more accurately. For example, standing and sitting can be effectively distinguished, and lying in bed versus lying on the ground can be recognized by adding an altimeter. When running, the wearable device will not shake randomly and can accurately recognize the number of steps and posture during running. Secondly, it can determine whether the wearer is unstable when standing or sitting, whether the body sways left and right when walking, and whether there is a risk of falling. The posture obtained from the IMU and altimeter measurements on the amulet completely synchronizes with the upper body posture of the user and can be compared with the criteria for various actions. If the deviation value exceeds the threshold, a warning can be issued.

In some embodiments, the amulet can also be compatible with the functions of a physiological wristband, forming an integrated whole and can be attached to the skin on the chest. It can simultaneously perform 1. Human activity recognition (IMU); 2. Sleep depth recognition (IMU); 3. Heartbeat or electrocardiogram (soft self-adhesive electrode); 4. Breathing (IMU); 5. Skin impedance (soft self-adhesive electrode); 6. Body temperature. Furthermore, the quality of sleep can be inferred from 2 and 4, and emotions can be deduced from the combination of 4, 5, and 6.

In some embodiments, the measurement values obtained from the amulet and physiological wristband, such as breathing, blood oxygen, HRV, or ECG, can be used to estimate sleep quality and sleep apnea.

The basic functions integrated into the amulet and physiological wristband allow users to include: 1. Safety: prevention and detection of falls; 2. Physical health: regular routines, sufficient sleep, normal medication use, smart exercise, drinking water, balanced diet, going to the bathroom, bowel movements, normal physiological signals, and bathing; 3. Mental health: good mood, engaging in various behaviors, especially eating three meals a day, normal heart rate, blood pressure, and skin impedance.

The function of the amulet is to send out broadcast packets every fixed period (e.g., 30 seconds) containing 1. Location, 2. Movement, and 3. Body posture (stable or unstable) 4. Body temperature (optional).

The IoT system of the present invention includes a tag (Beacon), router, gateway, and server; the beacon is composed of a Bluetooth 5.0 module and at least one is needed in each room of the home. The beacon is battery-powered and can be used by simply sticking it to the ceiling or wall of each room. The basic broadcast packet of the beacon is shown in Table 1. The amulet and physiological wristband both use Bluetooth 5.0 and can be directly uploaded to the router/gateway with a Bluetooth 5.0 module. This simplifies the system and reduces costs. For example, for 10 rooms or areas, 10 beacons are needed, and the price is about 65 USD. A router/gateway costs 65 USD. The beacon uses a larger capacity battery and broadcasts every second, 0.1 seconds at a time, so it can be replaced every six months or even once a year. When the battery is low, the router/gateway will be notified, and then the server will notify the user to replace the battery. The amulet uses the multi-role Bluetooth function, which can receive broadcast packets from the beacon and perform behavior recognition based on IMU measurements. In some embodiments, three or more beacons can be placed in each room or area to provide three-point positioning. In some embodiments, only the amulet uses Bluetooth 5.0 or higher versions, while the physiological wristband uses Bluetooth 4.0. The physiological wristband broadcasts to the amulet, and the amulet combines the measurement values from the physiological wristband with its own measured motion and behavior information to convert them into long Bluetooth 5.0 packets, which can be up to 245 bytes, and directly sent to the router/gateway and then to the cloud server.

In some embodiments, a dining table camera can be added to mainly capture activities on the dining table within a range of 80-150 cm above the table, such as the Intel RealSense-D430 camera. Based on daily schedules and Google Calendar events, the system can track activities that are scheduled, but it cannot track random eating activities. However, through location triggering, when the user stays in the dining table area, regardless of standing or sitting, the system can send the table location information to the cloud, and the cloud can push a request to the camera to take a picture and upload it to the cloud. Since the shooting range is only the dining table area and does not interfere with privacy, there is no major issue. In a restaurant, a dining table camera may also be needed to determine the type of behavior, such as eating, taking medication, drinking water, eating snacks, etc.

In some embodiments, smart speakers can be further added, one in the master bedroom and one in the guest/dining room, to proactively remind users or passively answer user inquiries.

In some embodiments, mobile smart speakers can also be added, such as Asus Zenbo, Temi, Amazon Astro, robot dogs, etc. These mobile robots not only have speakers but also include cameras that can recognize the environment and users. They can follow users or receive commands from cloud servers when users have abnormal physiological or biochemical signals, and go to the user's location for nearby monitoring and proactive reminders or passive answering of user inquiries. However, privacy issues may arise from the use of cameras. It is worth noting that robot dogs can even climb stairs and follow their owners outdoors. Therefore, the signals measured by the amulet and physiological wristband can be directly transmitted to the robot dog for relay to the cloud or processed directly on the robot dog's processor. In this way, the usage scenarios of the present invention can also be extended to outdoor activities.

The primary function of the server or cloud is to determine behavior. It must collect data from the amulet (or physiological wristband), such as physiological signals and movements, over a period of time (usually when the user leaves the location or finishes the behavior) to correctly determine the behavior in the same location, even requiring physiological signals. For example, going to the toilet may be for urination or defecation. If the user takes too long to defecate, they may be constipated. If the user defecates multiple times, they may have diarrhea. The duration of urination is usually no more than 3 minutes. After using the toilet, the user should turn to the sink to wash their hands.

The second function of the server or cloud is to determine the correlation between behavior and physiological signals, as referenced in “Customized physiological signal monitoring and alerting.”

The third function of the server or cloud is to provide reminders via a speaker or app based on the daily routine activities that have been pre-set. The feedback from the amulet is used to confirm whether the pre-set activities have been completed. If they have not been completed, the reminders will continue until they are finished, and the real schedule will be updated. For example, taking medication is a necessary activity that must be completed.

The fourth function of the server or cloud is to provide a pre-set daily activity schedule, which will be completed every day at midnight. The server or cloud will also include the physiological data and movement posture corresponding to the activities or behaviors in the activity schedule, which is the quality factor for the corresponding behavior.

### BRIEF DESCRIPTION OF THE DRAWINGS

FIG. 1 is a flowchart based on an embodiment of the present invention.

FIG. 2 is a schematic diagram of the setting of an area using an APP according to an embodiment of the present invention.

FIG. 3 is a schematic diagram of the positioning fingerprints of important locations in an indoor room according to an embodiment of the present invention.

FIG. 4 is a schematic diagram of the relationship between the use fingerprint and behavior of important furniture in a room according to another embodiment of the present invention.

FIG. 5 is a schematic diagram of an embodiment of the wearable amulet according to the present invention.

FIG. 6 is a state machine diagram according to an embodiment of the present invention.

FIG. 7 is a flowchart of partial behavior action recognition according to an embodiment of the present invention.

FIGS. 8A-8D illustrate an embodiment of detecting falling backward while standing according to the present invention.

FIGS. 9A-9D illustrate an embodiment of detecting falling to the left while standing according to the present invention.

FIG. 10 is an embodiment of detecting acceleration changes when lying on the front, side, and prone according to the present invention.

FIG. 11 is an embodiment of detecting standing and sitting at normal speed in terms of acceleration three-axis acceleration value and pitch value according to the present invention.

FIG. 12 is an embodiment of detecting falling forward while walking then lying on the right side according to the present invention.

FIG. 13 is an embodiment of detecting analyze the user's sleep posture and physiological data one night according to the present invention.

FIG. 14 is an embodiment of field map of home experiment according to the present invention.

FIG. 15 is an embodiment of comparing the test data with the set fingerprints according to the present invention.

FIG. 16 is an embodiment of detecting a person wearing the IMU device move around at home as shown in FIG. 14, the behavior trajectory is accurately illustrated according to the present invention.

### DESCRIPTION OF THE EMBODIMENTS

The following describes exemplary embodiments of the present invention in detail, which are shown in the accompanying drawings. The same or similar reference numerals throughout the drawings indicate the same or similar components or components having the same or similar functions. The exemplary embodiments described below with reference to the accompanying drawings are exemplary and are intended to explain the present invention and should not be construed as limiting the present invention.

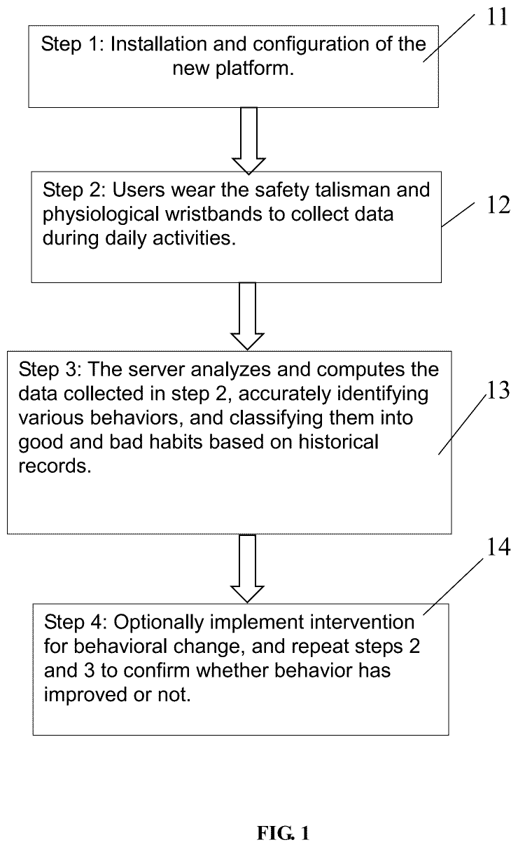

The operational sequence of the present invention, as shown in FIG. 1, includes the following steps: step 11, installation and setting of a new field; step 12, wearing an amulet and physiological bracelet by the user to collect data during daily activities; step 13, the server or cloud conducts analysis and computation on the data collected from the amulet, physiological bracelet, and even environmental sensors to accurately identify various behaviors and classify habits and bad habits based on historical records; step 14, selectively implementing behavior change interventions, and repeating steps 12 and 13 to confirm the improvement of behavior.

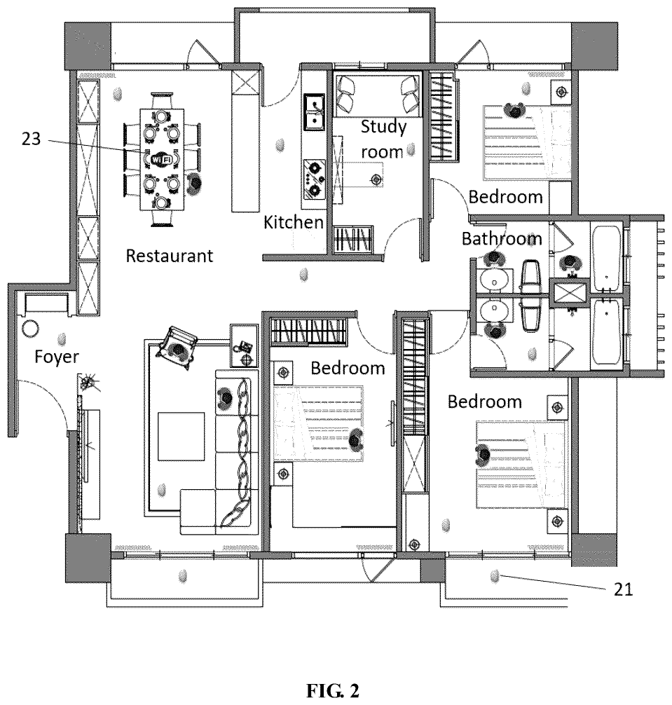

Regarding the installation and setup of the new domain mentioned in step 11, refer to FIG. 2. The best way to do this is to use the “Installation Setting APP,” which provides the following functions:

The APP assists the user in creating a floor plan of the field, including the positions of furniture in each room, as well as socket locations. Socket locations can be used to install Bluetooth communication nodes (Nodes). If a Bluetooth tag (beacon) 21 powered by a battery is used, it can be attached to indoor walls.

With the floor plan, the field user will install Nodes at the socket positions of each room. Alternatively, the tag (beacon) 21 can be attached to the indoor walls of each room. In addition, the Bluetooth-to-Wi-Fi router/gateway 23 (bwRouter/Gateway) is installed in a socket with a power supply, and a better installation position is in the center of the home field or above the dining table, where a camera above the dining table can be installed simultaneously. The Bluetooth-to-Wi-Fi router/gateway can be established using a Bluetooth module of 5.0 or higher with a Raspberry Pi module (such as Raspberry PI 4).

The field user wears an amulet and sets the magnetic fingerprints, RSSI, latitude and longitude, and user orientation of each piece of furniture in each room to complete the contents of Table 1.

TABLE 1
Home beacon data packet

| | beacon data byte [2-15] | | | 1 fingerprint databyte[16-32] | | | | | |
|---|---|---|---|---|---|---|---|---|---|
| | | | Room | Room | geomagnetic | | | | |
| | | | beacon | Code/ | finger | Geomagnetic | | | |
| byte[0-1] | | | installation | Furniture | print | strength | facing | | furniture |
| mode | people | hour | location | Code | 6 | 2 | 2 | RSSI | location |
| 2 bytes | 6 bytes | 2 bytes | 6 bytes | 1byte | bytes | bytes | byte | 2bytes | 4 byte |
| refer to | MAC | Second | longitude | Refer to | Mx | Ms | | | longitude |
| Table 3-1 | address | SS ms | x₃x₄x₅x₆ | Table 3 | My | | | | x₃x₄x₅x₆ |
| 3-2, 3-3 | | | latitude | | Mz | | | | latitude |
| ID is $ | | | y₃y₄y₅y₆ | | | | | | y₃y₄y₅y₆ |
| | | | high | | | | | | |
| | | | Z₁Z₂ Z₃Z₄ | | | | | | |

2 fingerprint data byte [33-49]

| Room Code/ | geomagnetic | Geomagnetic | | | furniture |
|---|---|---|---|---|---|
| Furniture Code | fingerprint | strength | facing | RSSI | location |
| 1byte | 6 byte | 2 bytes | 2 byte | 2bytes | 4 byte |
| Refer to | Mx | Ms | | | longitude |
| Table 3 | My | | | | x₃x₄x₅x₆ |
| | Mz | | | | latitude |
| | | | | | y₃y₄y₅y₆ |

3 fingerprint data byte[50-66]

| Room Code/ | Geomagnetic | Geomagnetic | | | furniture |
|---|---|---|---|---|---|
| Furniture Code | Fingerprint | strength | facing | RSSI | location |
| 3 (1byte) | 4 6 bytes | 2 bytes | 2 byte | 2bytes | 4 byte |
| Refer to | Mx | Ms | | | longitude |
| Table 3 | My | | | | x₃x₄x₅x₆ |
| | Mz | | | | latitude |
| | | | | | y₃y₄y₅y₆ |

4 fingerprint data byte[50-66]

| Room Code/ | Geomagnetic | Geomagnetic | | | furniture |
|---|---|---|---|---|---|
| Furniture Code | Fingerprint | strength | facing | RSSI | location |
| 3 (1byte) | 4 6 bytes | 2 bytes | 2 byte | 2bytes | 4 byte |
| Refer to | Mx | Ms | | | longitude |
| Table 3 | My | | | | x₃x₄x₅x₆ |
| | Mz | | | | latitude |
| | | | | | y₃y₄y₅y₆ |

The detailed steps are described below.

Step (1): The user wears the amulet and brings the mobile device to a room in the venue.

Step (2): Stand still in front of a piece of furniture or use the furniture. On the mobile device app, press the “Start Setup” button. The app notifies the amulet to broadcast the setting mode, and the amulet broadcasts the following information to the app: 1. The RSSI of the positioning broadcast packet sent by the Node in the room at that time, 2. The orientation of the amulet, and 3. The magnetic strength of the amulet. After the app receives this amulet packet, it accumulates at least 20 packets, calculates the average of RSSI, orientation, and magnetic strength, adds the latitude and longitude of the furniture position, and sets it as the fingerprint of the furniture in this room.

Step (3): After 5 seconds, the app informs the user that the calibration is complete and the user moves on to the next piece of furniture.

Step (4): Repeat steps (2) and (3) until all furniture has been calibrated and fingerprints obtained.

Step (5): The app connects with the Node and writes the fingerprints obtained in step (4).

Step (6): Move to another room in the venue and repeat steps (2)-(5) until all rooms in the venue are completed.

In order to perform field calibration, personnel need to wear the amulet directly to perform magnetic field value detection, and it is best to have a posture that matches the habitual posture when using the furniture. For example, when using a toilet, the user should stand facing the toilet or sit with their back to the toilet. When using a sink or washbasin, the user should stand facing the sink or washbasin and then brush their teeth, wash their face, wash their hands, shave, etc. When using a bathtub or showerhead, the user can face in any direction.

Step 2.13: The user wears the amulet and physiological wristband to collect data during daily activities. When the user wearing the amulet enters a room, they will receive the broadcast packet of the home Node in Table 1, and then obtain the magnetic field information from their location. By comparing it with the fingerprints in Table 1, the room name and furniture name in Table 3 are obtained. After completing Tables 4 and 3, broadcast packet in Table 2 is sent directly to the router (bwRouter) and uploaded to the cloud. In larger areas, the broadcast packet first goes through the Node and then the Bluetooth MESH to reach the bwRouter before being uploaded to the cloud. The physiological wristband can further measure biochemical signals, as described in the inventor's patent, Taiwan Patent No. 1730503 “Physiological and Biochemical Monitoring Device”. Therefore, it can generate physiological and biochemical data examples as shown in Table 5. Physiological data can generate one message every 1-5 seconds, while biochemical signals are generally every 1-10 minutes, with the ideal frequency being every 5 minutes. In some examples, the physiological signals are selected from heart rate, electrocardiogram, HRV, surface impedance, body temperature, blood oxygen, and blood pressure. The biochemical signals are selected from blood glucose concentration, lactate concentration, cortisol concentration, and drug concentration. In some examples, a miniature spectrometer can also be used to measure biochemical signals, which are integrated into the wristband along with the physiological signal sensors for real-time continuous monitoring of physiological and biochemical signals.

Table 2 shows the broadcast packet of the human-centric amulet

| | | | | | | | Wristband | |
|---|---|---|---|---|---|---|---|---|
| | | | bTag Original Data bytee[3-24] | | | | Additional | |
| | | | | | Room | | DataCbyte[25-50] | |
| | Byte[1] | | | | beacon | Object/ | Physiological | Biochemical |
| byte[0] | Device | Byte[2] | Who | Time | installation | event | signal | signal |
| Identifier | Identifier | Mode | (6 | (2 | location | (8 | (13 | (1-23 |
| (1byte) | (1byte) | (1byte) | bytes) | bytes) | (6 bytes) | bytes) | bytes) | byte) |

| | | | | | | | |
|---|---|---|---|---|---|---|---|
| 0x26 | Emergency | MAC | Seconds | Longitude | Reference | Refer to | Refer to |
| | 0x70 | address | SS | x₃x₄x₅x₆ | Table 3 | Table 5 | Table 5 |
| | Non- | | ms | Latitude | and | | |
| | Emergency | | | y₃y₄y₅y₆ | Table 4 | | |
| | 0x80 | | | Altitude | | | |
| | | | | Z1Z2 Z3Z4 | | | |

TABLE 3
Behavior recognition related to the object, event, and location of the amulet

| | Possible | | | |
|---|---|---|---|---|
| | Behavior | | | |
| | (reserved | | | |
| | 4 bits) | | Furniture Name | Action |
| | (typically | | in the Room | Sensor Value |
| | determined by | | (4 bits) | Interpretation |
| Sensor | cloud based | Room Code | Geomagnetic | 6 bytes, |
| Code | on uploaded | and Name | Fingerprint | Refer to |
| (4 bits) | data) | (4 bits) | Definition | Table 4 |
| 1111 | Eating, taking | 0000 | 0001 Chair A in dining | |
| | medicine, | Dining Room | table area 0010 Chair B | |
| | drinking water, | | in dining table area | |
| | eating snacks, | | 0100 Chair C in dining | |
| | etc. Further | | table area | |
| | recognized by | | 1000 Chair D in dining | |
| | camera | | table area | |
| 1111 | stir fry | 0001 | 0001 In front of gas stov | |
| | cook rice | Kitchen | 0010 In front of electric | |
| | Washing | | cooker or microwave | |
| | vegetables, | | oven | |
| | washing dishes, | | 0100 In front of cooking | |
| | etc. | | or dishwashing area | |
| | | | 1000 In front of hot | |
| | | | water dispenser or water | |
| | | | dispenser | |
| 1111 | 0000 Large toilet | 0010 | 0001 In front of toilet | based on the |
| | 0001 Small toilet | Bathroom | 0010 In front of wash | duration of |
| | Washing face, | | basin | stay |
| | brushing teeth, | | 0100 In shower area | Asking by |
| | washing hands | | or bathtub | the speaker if |
| | Taking a shower, | | 1000 In other areas | the user is |
| | washing clothes, | | | brushing |
| | etc. | | | teeth |
| 1111 | 0000 Watching | 0011 | 0001 Sofa A in | Asking by |
| | TV | Living Room | front of TV | the speaker? |
| | 0001 listening to | | 0010 Sofa B in | |
| | music | | front of TV | |
| | 0010 chatting | | 0100 Sofa C in | |
| | Doing exercise | | front of TV | |
| | | | 1000 In other areas | |
| 1111 | 0000 Sleeping, | 0100 | 0001 Bed | |
| | resting in bed | Master | 0010 In front of | |
| | Dressing up | Bedroom | the mirror | |
| | Changing clothes | | 0100 In front of | |
| | | | the wardrobe | |
| | | | 1000 In other areas | |
| 1111 | Sleeping, resting | 0101 | 0001 Bed | |
| | in bed Reading, | Bedroom A | 0010 On the desk | |
| | using computer | | 0100 In front of | |
| | Changing clothes | | the wardrobe 1000 | |
| | | | In other areas | |
| 1111 | Sleeping, resting | 0110 | 0001 Bed | |
| | in bed Reading, | Bedroom B | 0010 On the desk | |
| | using computer | | 0100 In front | |
| | Changing clothes | | of the wardrobe | |
| | | | 1000 In other areas | |
| 1111 | Washing clothes, | 0111 | 0001 (Washing | |
| | taking care of | Balcony A | machine); 0010 | |
| | plants, drying and | | (Plant area); 0100 | |
| | collecting clothes | | (Other areas) | |
| 1111 | | 1000 Room | | |
| | | A | | |
| 1111 | | 1001 | | |
| | | Basement | | |
| 1111 | | 1010 | | |
| | | Reserved | | |
| 1111 | Smoking, | 1011 | | |
| | drinking alcohol | Behaviors | | |
| | | not related to | | |
| | | location | | |

TABLE 4
Interpretation of Sensor Information from the amulet

| event | event | Normal sensing value |
|---|---|---|
| (behavior) | quality | content or warning |
| 4 bits | 4 bits | value (statistical |
| | | value within |
| | | 30 seconds) 5 bytes |
| 0000 sit | 0000 normal | 30-second averages of |
| | 0001 uneasy | normal pitch, roll, yaw, |
| | | The frequency of body |
| | | shaking (pitch, roll, yaw) |
| | | exceeding the normal |
| | | value is 10 times/minute |
| 0001 stand | 0000 normal | Normal |
| | 0001 unstable | The frequency of body |
| | | shaking (pitch, roll, yaw) |
| | | exceeding the normal |
| | | value is 10 times/minute |
| 0010 walk | 0000 normal | steps, speed |
| | 0001 unstable | The frequency of body |
| | | shaking (pitch, roll, yaw) |
| | | exceeding the normal |
| | | value is 10 times/minute |
| 0011 run | 0000 normal | Step count, speed |
| | 0001 unstable | (1 byte, 0-25.5km/hr), |
| | | The frequency of body |
| | | shaking (pitch, roll, yaw) |
| | | exceeding the normal |
| | | value is 10 times/minute |
| 0100 fall | 0001 mild | Fall detection: total |
| | 0010 Moderate | acceleration (byte) |
| | 0011 Severe | 0-25.5 m/sec2, HEX |
| | | The direction of the |
| | | fall can be judged |
| | | by (pitch, roll, yaw) |
| 0101 lie | 0000 sleep | Sleep monitoring: divided |
| | 0001 light sleep | into 4 levels, turning |
| | 0010 deep sleep | over, getting up, |
| | 0011 break | light sleep time, |
| | 0100 | deep sleep time |
| 0110 breathe | | breaths per minute |
| | | Upload every 5 seconds |
| | | Upload the number |
| | | of breaths in |
| | | the previous minute |
| 0111 | reserve | reserve |
| 1001 move | | Accelerometer output: |
| | | three axes (averaged |
| | | over 30 seconds) |
| 1010 | | Activity monitoring: |
| | | 4 levels (4 bits), |
| | | Calories |
| | | consumed (12 bits, |
| | | 0-4095 calories) |
| 1100 | | reserve |
| 1101 | | reserve |
| 1110 | | reserve |
| 1111 | | reserve |

TABLE 5
Example of Physiological and Biochemical Data Implementation

| | | | | | | | | biochemical signal | | |
|---|---|---|---|---|---|---|---|---|---|---|
| Physiological bracelet information byte[25-37] | | | | | | | | byte[37-42] | | |
| Step | | | | heart | body | blood | blood | blood | lactic | taking |
| count | mileage | calories | electricity | rate | temperature | oxygen | pressure | sugar | acid | medicine |
| 2 | 2 | 2 | 1 | 1 | 2 | 1 | 2 | 2 | 2 | 2 |
| byte | byte | byte | byte | byte | byte | byte | byte | byte | byte | byte |

Due to certain situations, the fingerprint data from Table 1 may not have a high resolution for locating a specific position in a room, such as within a one-meter radius. In such cases, the location function of the amulet can be utilized, which uses a state machine to determine the specific location based on clear behavioral patterns at a given location. For example, if a user sits down in a bathroom, it can be inferred that the location is the toilet, and when the user stands up, turns around, takes a step, and walks towards a different location (B), the processor can determine that the user is currently at location B, despite the magnetic fingerprint, RSSI, and direction being similar to location A. In other words, when there are multiple possible locations in a room with similar fingerprints, the processor can use the previously determined location (longitude and latitude) to estimate the next location based on the user's walking trajectory and posture changes. By combining this with the location (longitude and latitude) fingerprint, the positioning can be accurately done, especially for behavior-based positioning.

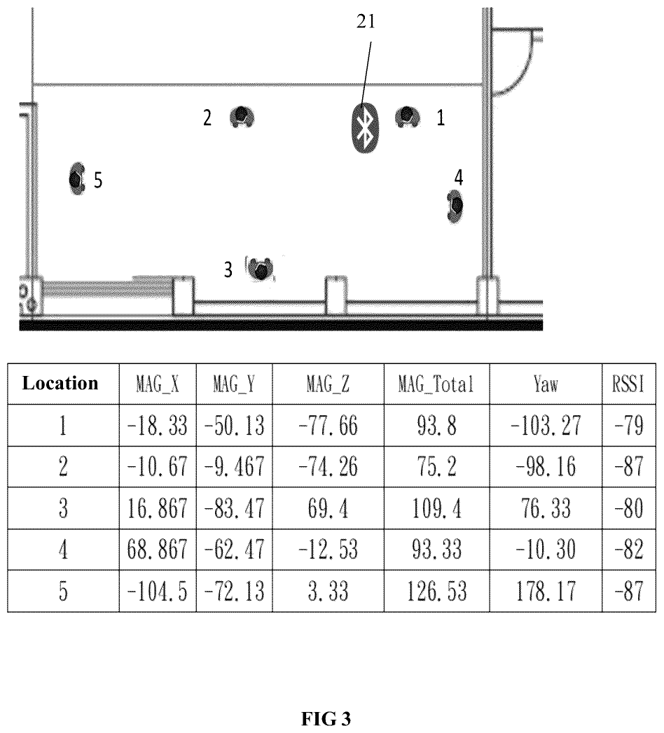

To further illustrate this point, refer to FIG. 3, which shows the schematic diagram of the positioning fingerprint of important locations in a room according to the present invention. Because the amulet can calculate relative motion trajectories from the accelerometer, gyroscope, and compass, as long as there is a static starting point as a reference, the trajectory can be calculated by combining the pedometer and yaw and can be expressed in longitude and latitude.

In other words, in this architecture, the algorithm of Pedestrian Dead Reckoning (PDR) is used, which is based on the principle of using sensors to calculate the number of steps and heading angle from a known position to estimate the next position or to calculate the walking distance based on the user's steps. In this embodiment, many fixed pieces of furniture are utilized, such as toilets, sinks, bathtubs, gas stoves, sofas, and chairs, which are usually not moved from their original locations, so they can provide a reliable position. When the user leaves this location, it becomes the starting point, and the pedometer and IMU are used to determine the orientation, and these readings are used in the PDR to calculate the next position.

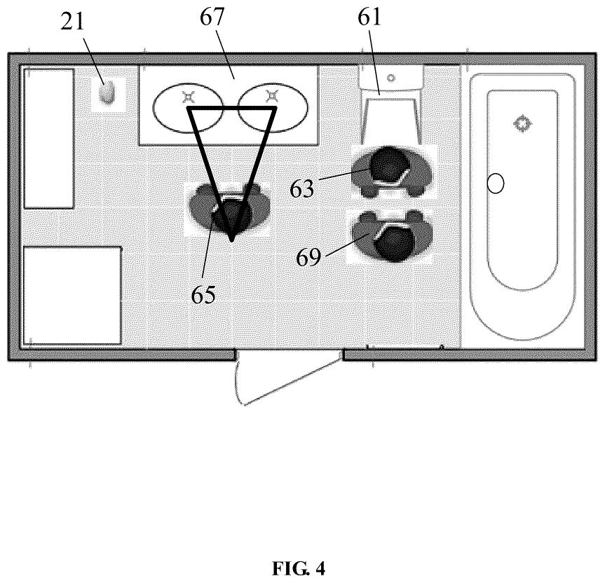

Reference FIG. 4 shows a schematic diagram of the relationship between fingerprint and behavior of important furniture in indoor rooms according to the present invention. Bluetooth tag 21 actively broadcasts data packets to the amulet of the user. Taking toilet 61 as an example, if the user is male 69, facing the toilet 61, and displaying a behavior of small bowel movement. If male 63 is facing away from the toilet 61, sits down and stays for a while, it may be a behavior of large bowel movement. If user 65 is facing the washbasin 67, his behavior is washing face, washing hands, or brushing teeth.

The amulet of the present invention is built in with a 9-axis IMU and an altimeter, which can obtain BLE RSSI and geomagnetic fingerprints from communication nodes or tags, and calculate PDR with the IMU of the amulet itself. Therefore, it can achieve sufficient positioning accuracy, and the required density of communication nodes or tags can be said to be the most concise solution in practice, only one communication node or tag per room is required, and Bluetooth does not need to provide the function of three-point positioning.

In the implementation of the present invention, the signal pattern matching method can be used. In the offline stage, a feature database will be established. Basically, each area or room will have n reference points, preferably 4-5 reference points. The feature data of a reference point includes position (latitude and longitude), x (x-axis magnetic component), y (y-axis magnetic component), z (z-axis magnetic component) and F (composite magnetic intensity), RSSI, and direction, as shown in Table 1. When the current feature data is received in the online stage, this data will be compared and estimated with all features in the feature database to determine the current position of the user. The steps are as follows:
The first step is to assume that there are n reference points, and their corresponding feature data of sampling points include magnetic field strength Fi, Bluetooth communication strength RSSIi, direction i, longitude and latitude (Pxi, Pyi), i=1, . . . , n. First, calculate the average strength of each feature component, and then calculate the standard deviation of each feature component. º

In the second step, for those with larger standard deviations, it means that their recognition ability is better. Therefore, a larger weight is given, and the weight W is set to the sum of the standard deviations of each feature. The weight of each axis is set to the ratio with W.

In the third step, when the magnetic field components of each axis of the user's current position are received, they are compared with the feature data of each axis in the offline stage. The minimum difference with the feature data is calculated to estimate the corresponding reference point position P, and the user's current position is estimated.

In the fourth step, the amulet of the present invention's wearable device can receive 5 to 10 feature data per second. Therefore, the method of the third step can calculate 5 to 10 location results per second, and the best location can be calculated using the KNN method. The user's behavior can be inferred from the corresponding furniture of that location and the user's actions, as shown in Tables 3 and 4.

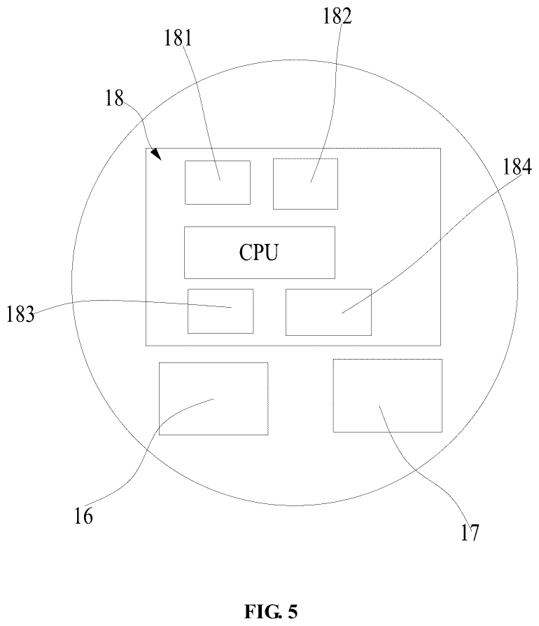

The implementation of the wearable amulet of the present invention is shown in FIG. 5, which is built-in with a nine-axis inertial sensor (BMX160) 181, a barometric pressure sensor (BMP280) 182, and other sensors. It also includes a battery 16, an emergency button 17, an antenna 183, a temperature sensor 184 (optional), a circuit board 18, and a CPU with a Bluetooth module. The nine-axis sensor includes a three-axis accelerometer, a three-axis gyroscope, and a three-axis magnetometer, which can be used for posture recognition and limb rotation. It can measure acceleration, angular velocity during rotation, and magnetic direction to calculate the amulet's rotation angle and movement distance. The wearable device can determine its current behavior, such as sitting, standing, or walking, for positioning, without the need for fixed tags. The difference between the two is whether physiological information such as sitting posture, standing posture, or drinking water can be collected.

Through the Madgwick algorithm (gradient descent algorithm), the posture obtained from the accelerometer and magnetometer after calculation and the posture obtained from integrating the gyroscope are linearly fused to obtain the optimal posture, thus obtaining the Roll, Pitch, and Yaw three-axis rotation angles with higher accuracy. The combined force G value and Pitch value calculated from the square root of the sum of the squares of the three-axis accelerations are used to determine the sitting or standing behavior. The barometric pressure sensor is also used to detect relative altitude changes, which assist in posture recognition and behavior identification.

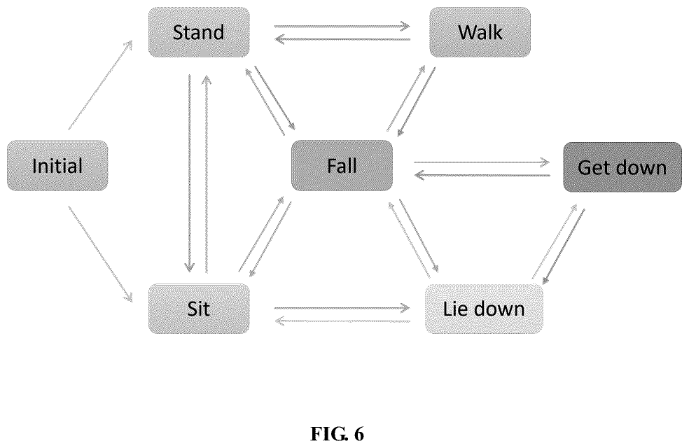

Referring to FIG. 6, a finite-state machine (FSM) is used to switch between behavioral states and perform corresponding events based on the current state. The FSM, also known as a finite-state automaton, is a mathematical computational model that represents a finite number of states and behaviors, such as transitions and actions, and has a wide range of applications in the field of computer science. FSM is an efficient internal logical unit programming method that allows servers to perform corresponding logical processing based on different states or message types, making program logic clear and easy to understand. FSM can be classified into Moore state machines and Mealy state machines. The former refers to a finite-state automaton whose output is determined solely by the current state, that is, the output can be considered a function of the current state. The latter generates output based on its current state and input, and the output signal is not only related to the current state, but also to all input signals, so the output can be considered a function of the current state and all input signals. As human behavior is unpredictable and subject to change, some behaviors cannot be anticipated. As shown in FIG. 6, it is first divided into states such as standing, sitting, walking, lying, and falling. When the current behavioral state is standing, the predicted next behavior may be falling or walking, or sitting, and so on. However, falling is a sudden event that can happen at any time under any behavioral pattern, as well as other unforeseen circumstances. Therefore, in the design of the amulet program, the concept of Mealy state machine is used to determine how to switch between behavioral modes. By comparing the input state with the current state, if the mutual relationship of the behavioral state is met, the corresponding function action is executed, and the state is jumped to the next state. Initially, when the wearable device is turned on and does not know whether the current state is sitting, standing, or walking, it is set to the initial state, and the current state is determined based on the first behavioral state executed. For example, when a person is standing and puts on the wearable device, the next behavioral state will either be standing up or sitting down. If the next behavior is standing up, the standing up function is executed and the initial state of the current state is jumped to the standing up state. If the current state is standing, and the input state is sitting down, the state machine will not execute the corresponding sitting down function, nor will it jump to the sitting down state, thus constraining behavior and reducing the probability of misjudgment.

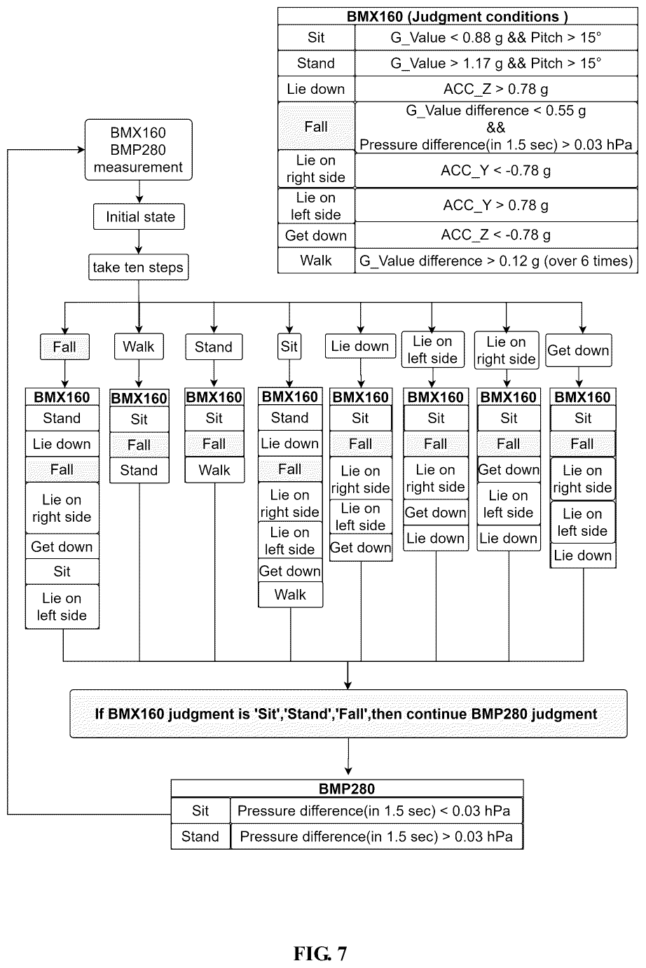

In some embodiments, in addition to the nine-axis IMU, a barometric altimeter can be added to the sensor of the amulet. By using sensor fusion technology, various behaviors can be accurately identified. Referring to FIG. 7, a partial behavior action recognition flow chart according to an embodiment of the present invention.

Fall detection: 1. Changes in altimeter (average air pressure value): from 120-150 cm (standing) to 15-25 cm (falling), with a change of at least 80 cm, which needs to be calibrated according to the wearer's height. IMU judgment is performed. 2. Pitch angle changes from 0 degrees to 80-90 degrees. 3. Ax changes from −1 g monotonically to 0.

Fall prediction and prevention: 1. pitch>+−5 degrees/step appears in 70% of continuous 10 steps; 2. roll>+−5 degrees/step appears in 70% of continuous 10 steps.

Walking detection: 1. Altitude is greater than 120-150 cm (calibrated according to the wearer's height). 2. The Az of IMU has periodic high and low changes.

Step counting function: 1. Altitude is greater than 120-150 cm (calibrated according to the wearer's height). 2. The Az of IMU has periodic high and low changes. Count one step for each period.

Standing detection: 1. Altitude is greater than 120-150 cm (calibrated according to the wearer's height). 2. Detected by the IMU signal from sitting to standing or from walking to stopping.

Sitting detection: 1. Altitude is 80-90 cm (calibrated according to the wearer's height). 2. Detected by the IMU signal from standing to sitting.

Getting up detection: 1. Altitude is 80-90 cm (calibrated according to the wearer's height). 2. Detected by the IMU signal from lying down to sitting. 3. Ax changes from 0 monotonically to −1 g.

Bedridden Detection: 1. Altitude measurement of 40-50 cm (calibrated according to the height of the wearer); 2. Detection of IMU signal from sitting to lying down; 3. Ax changes monotonically from −1 g to 0.

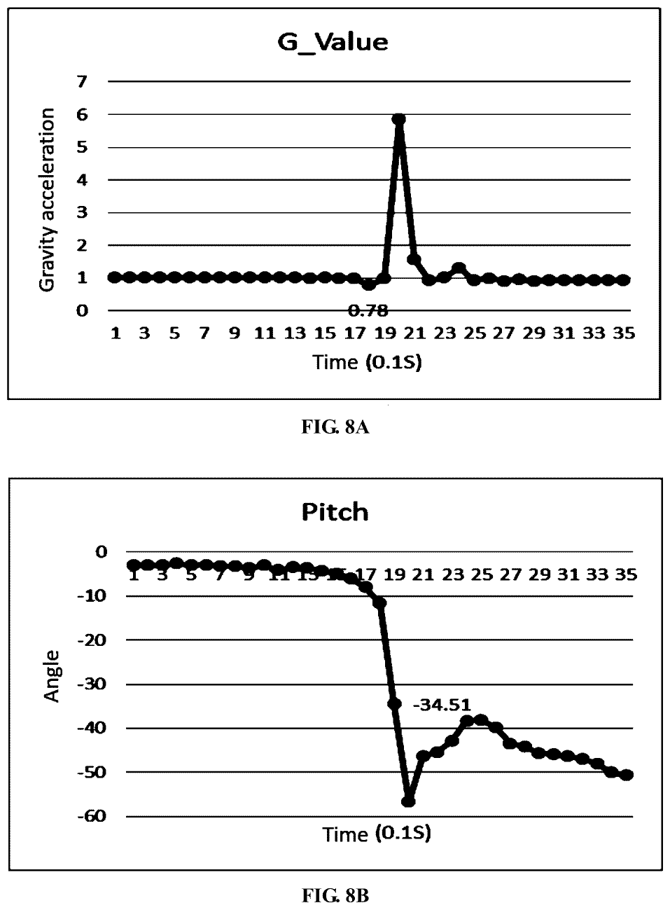

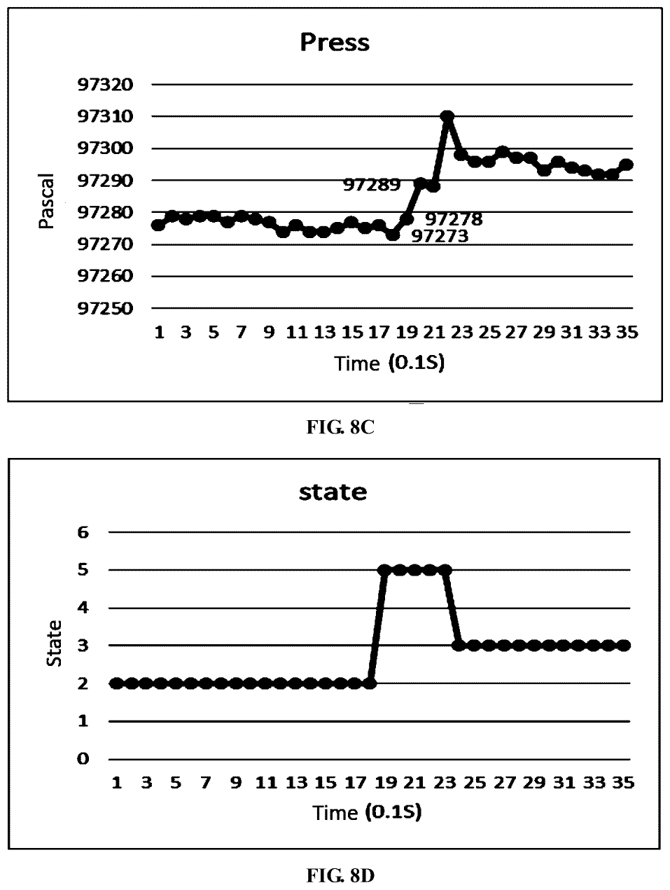

Referring to FIGS. 8A-8D, an implementation example of detecting falls when standing according to the present invention is shown. As shown in FIG. 8A, the total change in three-axis acceleration (G_value) can instantaneously increase from 1 g to 6 g. The magnitude of this change can be proportionally inferred as the force or severity of the fall. At the same time, as shown in FIG. 8B, the forward tilt angle (pitch) of the upper body changed from 0 degrees to −56 degrees, indicating a backward fall. As shown in FIG. 8C, the altitude of the amulet (i.e., pressure altitude) increased from 97280 Pa to 97310 Pa, indicating a decrease in height. Therefore, the state machine judgment in FIG. 8D changes from standing (state 2) to falling (state 5) and lying down (state 3).

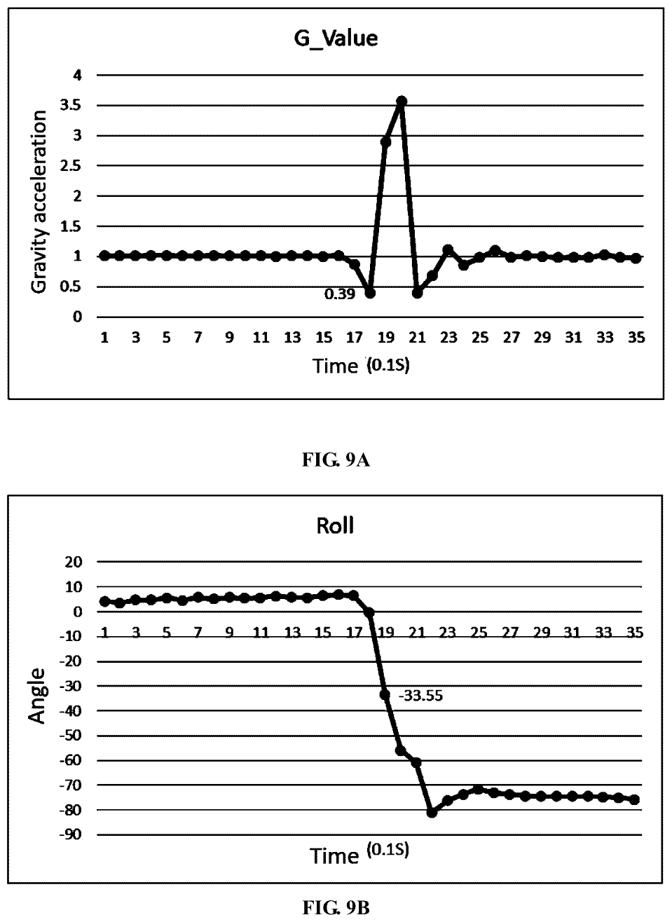

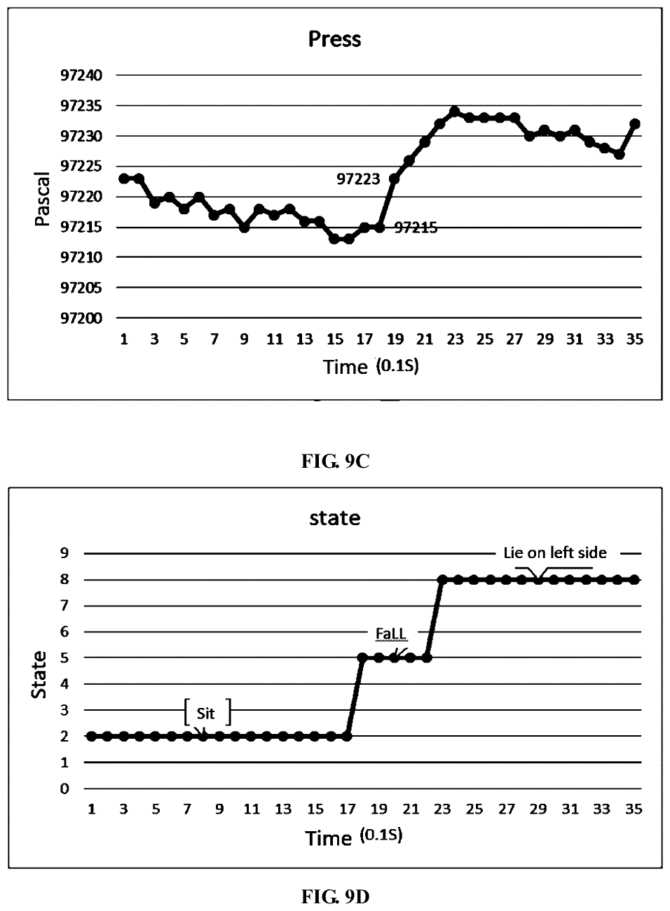

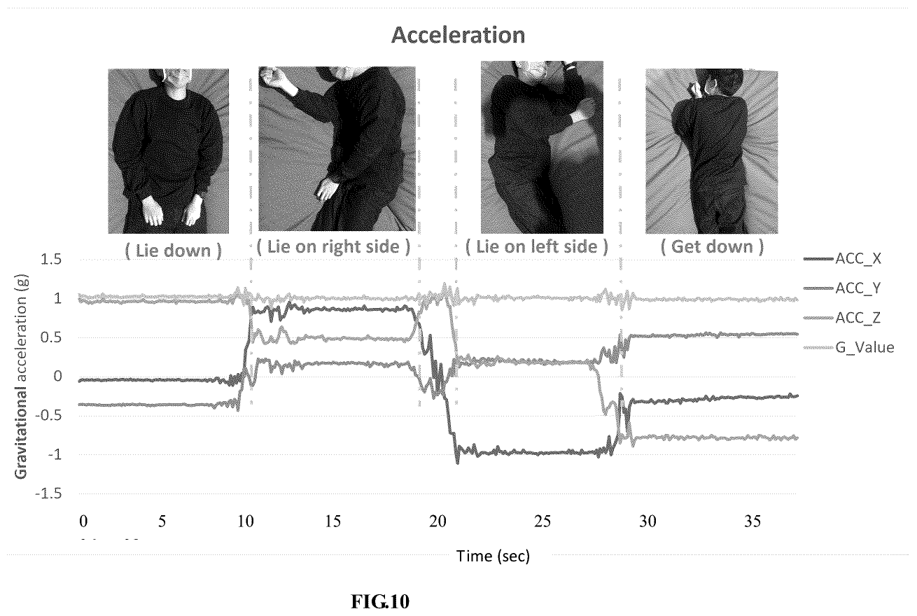

Referring to FIGS. 9A-9D, an implementation example of detecting falls to the left when standing according to the present invention is shown. As shown in FIG. 9A, the total change in three-axis acceleration (G_value) can instantaneously increase from 1 g to 3.5 g. The magnitude of this change can be proportionally inferred as the force or severity of the fall. At the same time, as shown in FIG. 9B, the swing angle (roll) of the upper body changed from 0 degrees to −80 degrees, indicating a fall to the left. As shown in FIG. 9C, the altitude of the amulet (i.e., pressure altitude) increased from 97215 Pa to 97235 Pa, indicating a decrease in height. Therefore, the state machine judgment in FIG. 9D changes from standing (state 2) to falling (state 5) and lying down to the left (state 8).

From the examples shown in FIGS. 8A-8D and 9A-9D, and the related falling experiments conducted in the present invention (not all experimental values are fully displayed), including backward falls, forward falls, falls to the right, falls to the left, and falls in any direction, a nine-axis IMU and altimeter fixed to the chest with a limited state machine algorithm can accurately determine the direction, force, and posture maintained after a fall occurs, as well as whether the fall occurred while standing, sitting, walking, or running. Additionally, the invention can detect whether the person who has fallen can move, sit up, or stand up. Compared to conventional techniques that can only detect the occurrence of falls, and may even produce false positives, the present invention demonstrates a significant improvement in fall detection.

In some embodiments, the amulet can detect the quality of sleep, mainly by detecting the frequency and number of changes in sleeping positions, such as sleeping on the back, stomach, right side, and left side. During the sleep process, the frequency and presence of breathing interruptions can also be detected. As the amulet is fixed to the chest, where the greatest fluctuations in chest breathing occur, and equipped with high sensitivity and low noise and drift IMU, it can accurately judge the breathing conditions. In addition, getting up during sleep involves transitioning from lying to sitting, then from sitting to standing away from the bed, making it easy to determine if one gets up to use the bathroom or move quickly, which may increase the risk of falling. Furthermore, if there are anomalies in heart rate, blood pressure, or blood oxygen levels during sleep, it may indicate poor sleep quality or related diseases.

The basic posture judgment is carried out according to the flow chart of behavior pattern judgment in FIG. 7. The system can use the accelerometer of the nine-axis inertial sensor to judge postures such as lying down on the front, lying on the left and right sides, and lying down. By observing FIG. 10, the difference between the four postures and the three-axis acceleration values, the system can determine the right action.

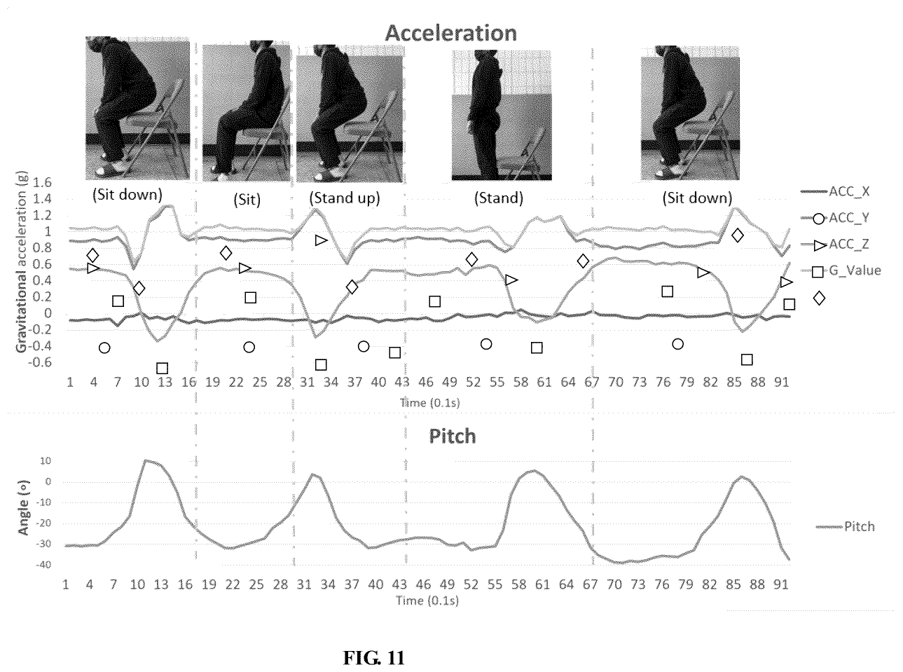

As shown in FIG. 11, when sitting down and standing up, the resultant value of the three-axis acceleration will have obvious peaks and troughs. This method of judging the behavior of sitting down and standing up can only be accurately interpreted if there are obvious waveforms. However, even standing up slowly, the relative altitude increases after stabilization, and the air pressure value decreases.

### Fall Action Judgment

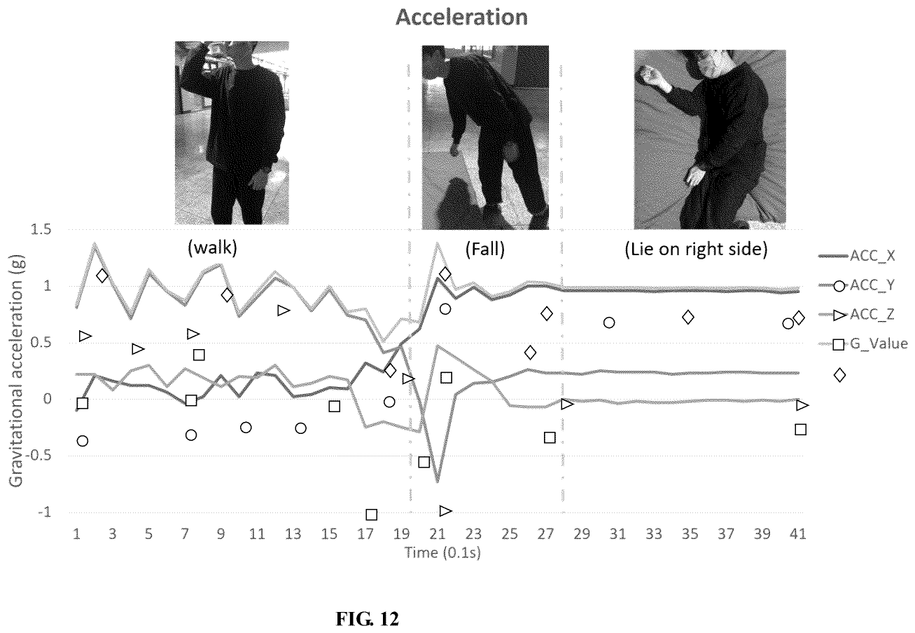

The system can test fall detection in different postures, for example, as shown in FIG. 12, to know whether the device can judge the fall. The main basis is the reduction of the acceleration three-axis resultant value. Different ways of falling cause different injuries to the user. After the experiment, it can be known that the weight loss when falling is more than that when sitting down, and the peak value after weight loss is also larger than that when sitting down. The article mentions that the peak value of the wave after falling is the impact force suffered by the tester, and the posture of falling and touching the ground is judged through the combined force of the three axes of acceleration. Different postures of touching the ground will cause different risks of injury to the body, and the caregivers can quickly understand the condition of the injured.

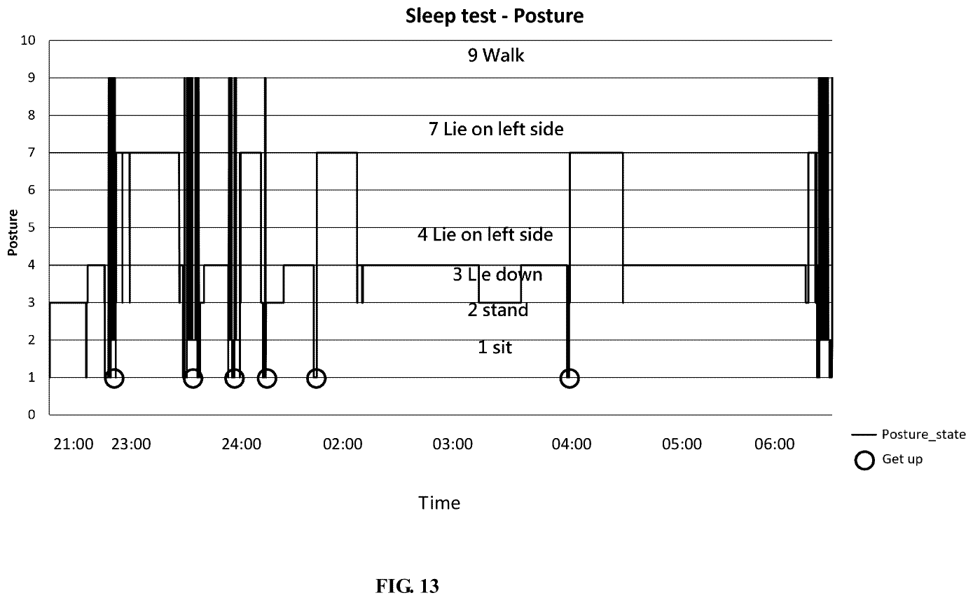

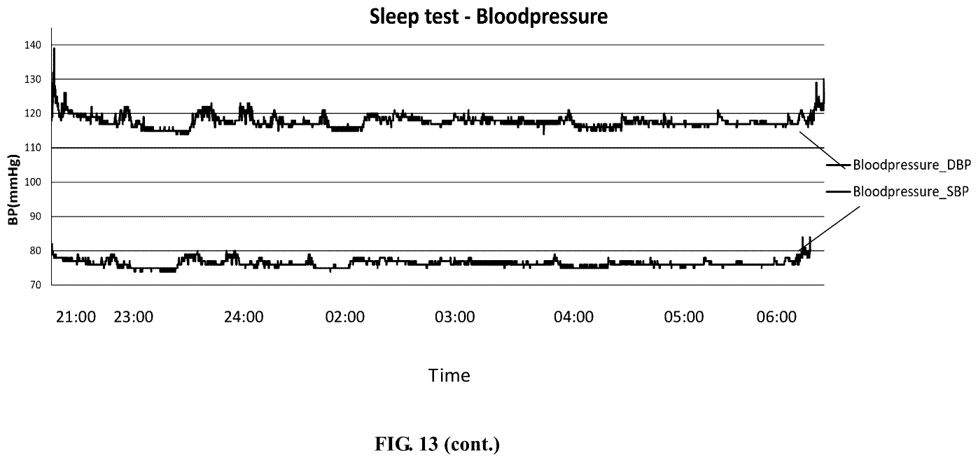

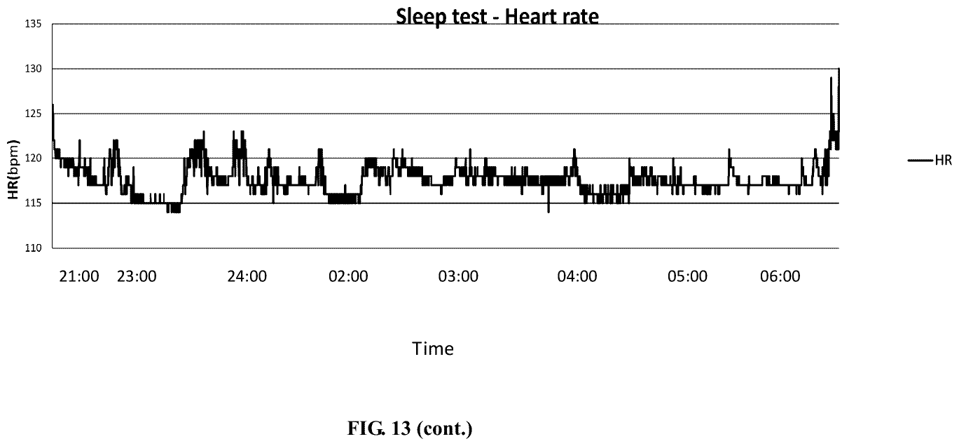

Based on the above experiments, the system of FIG. 2 at home can be set, recorded the user's posture behavior for one night, and observed the wearer's posture changes during sleep. From FIG. 13, the system can know that the wearer has whether to turn over or get up and walk, whether to interrupt sleep, with the physiological bracelet (blood pressure, heart rate), can analyze the user's sleep posture and physiological data.

Such data analysis can help medical professionals understand the sleep quality of the subjects, and give appropriate sleep suggestions and methods to improve the sleep quality and overall health status of the elderly. In addition, the system can also help the elderly to avoid falls when leaving the bed and ensure their safety through the fall detection function.

### Home Environment Positioning Setting

People's living habits at home and the placement of furniture are closely related. In the home environment, the placement of large furniture is fixed, which makes people's position, posture, and orientation fixed when using furniture at home. Therefore, the current posture, position, and orientation of the wearer can be used to infer the wearer's behavioral events.

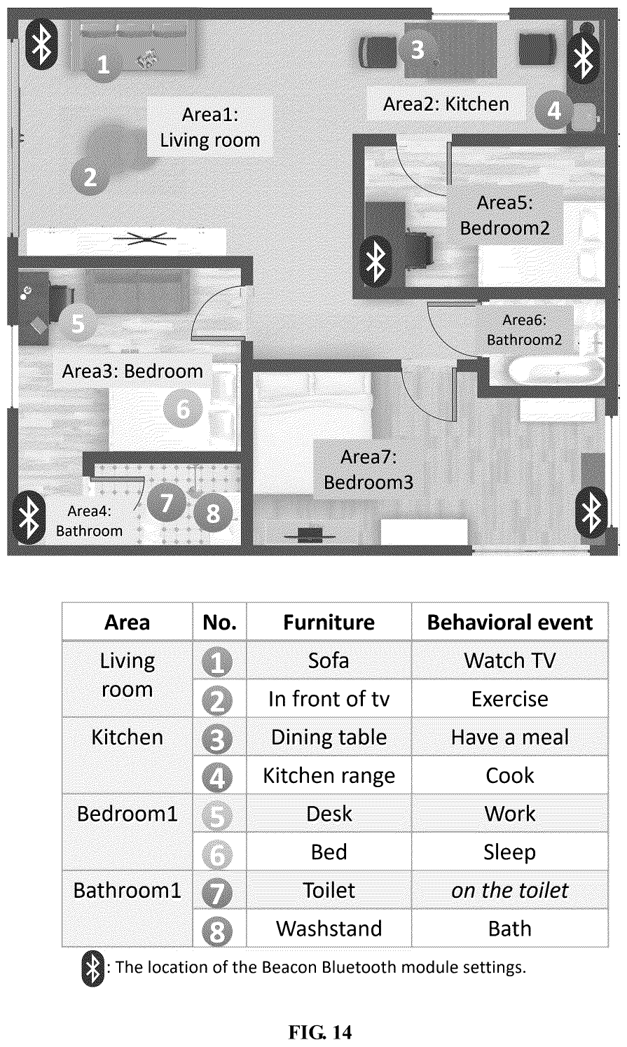

As shown in FIG. 14, the system can set eight daily behavioral events in the home environment, use the device's nine-axis inertial sensor to record the magnetic force of three axes at each point in FIG. 14, and measure the RSSI signal strength of the wearable device and the Beacon Bluetooth module placed in each area, and store the measured results in the Beacon Bluetooth module in each area as a fingerprint of behavioral events. When the wearer uses the device, it scans the fingerprint package of the closest Beacon Bluetooth module, and with the location and orientation of the area, he or she can locate the area and get the behavioral event by comparing the fingerprint with the posture. For example, sitting on the sofa in the living room facing the TV is watching TV, standing in the bathroom facing the toilet is urinating, or lying on the bed facing the ceiling which can deduce that the behavioral event is sleeping.

Indeed, the difference between the test points in the same direction using a magnetometer alone is not large enough to judge, and it is not easy to distinguish the area where the user is located. Therefore, it is necessary to scan the RSSI signal strength between the device and the Beacon module, and the strongest signal is the closest area, and then use the magnetometer to distinguish the faces in the area, which is an additional parameter of relative distance, so that the positioning points in the same direction can be better distinguished, and add the posture to distinguish their behavioral events. For example, in front of a sofa (test point 1) and a TV (test point 2) both facing the same direction, the RSSI signal strength can be used to distinguish between the two positions, and then between sitting and standing to distinguish whether the wearer is watching TV or exercising.

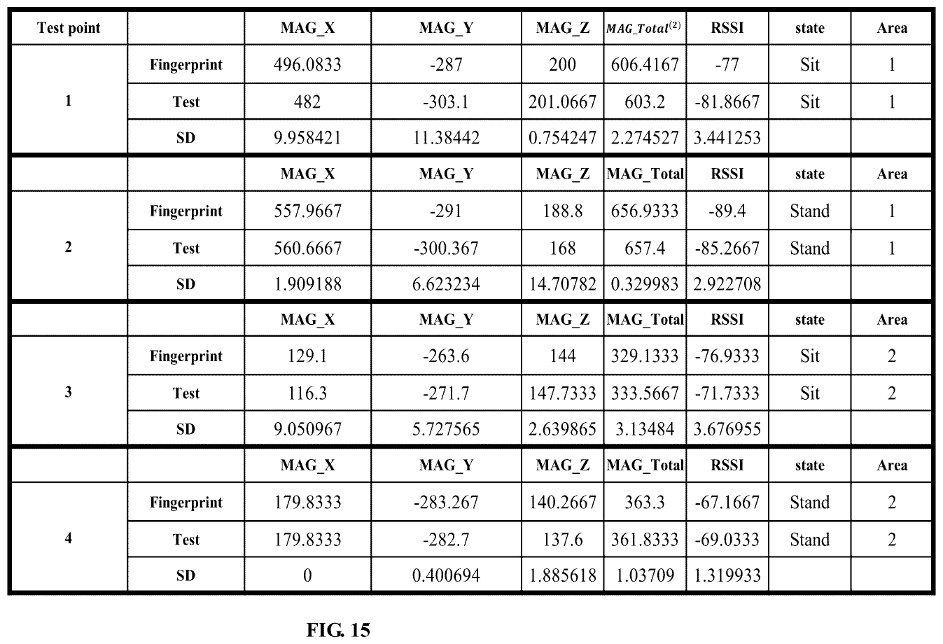

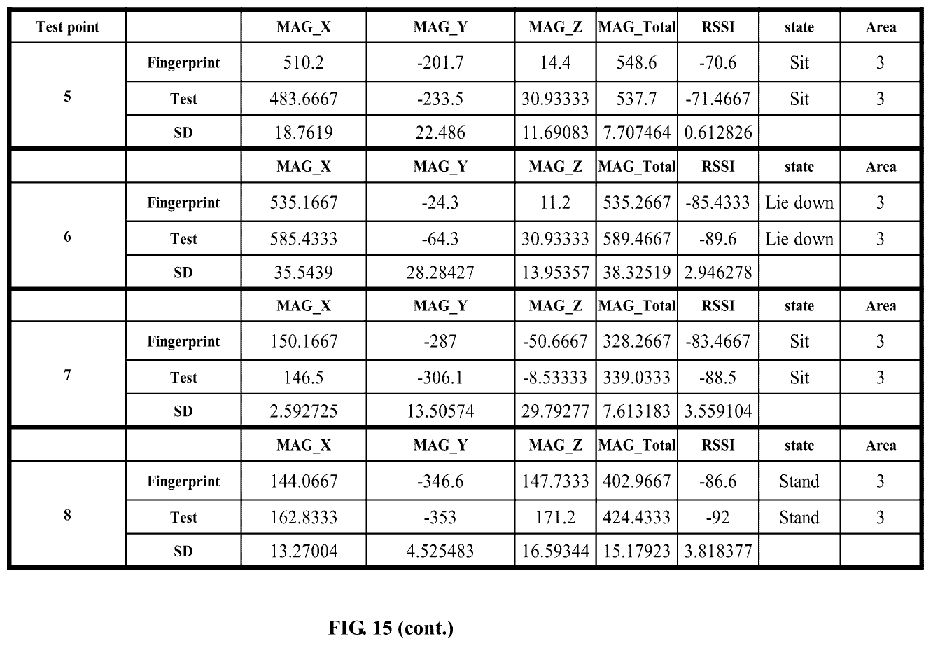

After a setting process held at home in FIG. 14, the fingerprint map is shown in FIG. 15, where the resultant magnetic field strength MAG_{Total} is shown in equation

$${MAG}_{Total} = \sqrt{{MAG}_{x}^{2} + {MAG}_{y}^{2} + {MAG}_{z}^{2}}$$

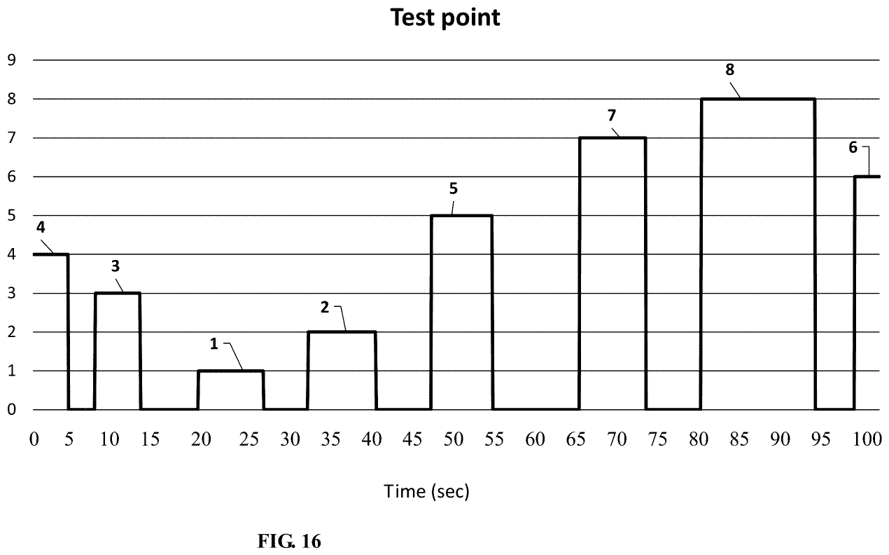

Although the magnetometer will not be interfered with by the magnetic field of electrical appliances, the magnetic field of the earth will change over time, and there will be differences in the same position at different time points. In addition, because the body orientation of the tester to the positioning point is different each time, there may be differences. Therefore, it is necessary to add displacement and movement angle information in the future to assist in the determination, such as the posture at each location, the direction of rotation from the current location to the next location, the number of steps required to move, the distance to move, etc. Referring to FIG. 15, a person wearing the IMU device move around at home as shown in FIG. 14, the behavior trajectory is accurately illustrated in FIG. 16.

In summary, through the location-based MESH Internet of Things, wearable devices (a chest attached IMU and a physiological bracelet), continuous biochemical sensors (glucose, lactic acid, insulin, alcohol, cortisol, etc.), diet records, etc., the present invention with AIOT can convert actions into behaviors. Combined with the records of physiological/biochemical signals, real-time personalized daily life routines can be reconstructed (also become accurate historical health records or real world data), which can be further transformed into interpretations of bad habits and good habits. Through active personalized reminders and detection feedback, based on the smart speaker equipped with GPT4's powerful dialogue ability, the proposed digital health intervention (DHI) system may increase user adherence, confirm the immediate/short-term/long-term effects of COACH, and finally turn bad habits into good habits, and optimize the health management of diabetic patients. This system may successfully prevent or reverse chronic diseases from becoming an emergency, and it may be possible to prevent the occurrence of chronic diseases and significantly reduce global medical expenditures.

In the description of this specification, the use of terms such as “an embodiment,” “some embodiments,” “examples,” “specific examples,” or “some examples” refers to one or more embodiments or examples of the present invention that include the specific features, structures, materials, or characteristics described in conjunction with that embodiment or example. In this specification, the indicative expression of these terms should not be construed as necessarily referring to the same embodiment or example. Moreover, the specific features, structures, materials, or characteristics described may be combined in an appropriate manner in any one or more embodiments or examples. Additionally, those skilled in the art may combine and assemble different embodiments or examples described in this specification.

Although exemplary embodiments of the present invention have been disclosed and described above, it is understood that such embodiments are for illustrative purposes only and should not be construed as limiting the invention. Those skilled in the art can make variations, modifications, substitutions, and alterations to the exemplary embodiments within the scope of the invention.

What is claimed is:

1. A human behavior recognition system comprising of
a chest-worn device and an IOT system, wherein the chest-worn device includes a nine-axis inertial motion unit (IMU), a barometer, a wireless communication module, and a microprocessor; the user attaches the chest-worn device to their chest to determine their movements; the IOT positioning system's nodes or beacons are installed in various areas of the living space and broadcast packet information to the chest-worn device; the packet information includes the node or beacon's preset latitude, longitude, and altitude coordinates, the area name where it is installed, and the name of each key furniture item within the area, along with its corresponding magnetic fingerprint and RSSI, the corresponding latitude and longitude, and the user's orientation when using the key furniture item; the chest-worn device integrates the user's movements with the broadcast packet information and uses a state machine to perform direct calculations, thereby accurately recognizing the user's behavior; the chest-worn device then broadcasts the relevant information it has acquired.

2. The system of claim 1, wherein the chest-worn device is fixed to the skin on the chest using a biomimetic non-gel self-adhesive backing or fixed to the chest using Velcro and attached to the wearer's clothing with a necklace.

3. The system of claim 1, wherein the chest-worn device detects the direction and impact force of falls, or detect unstable standing or movement to prevent falls.

4. The system according to claim 1, further includes a physiological and biochemical signal detection wristband, which synchronously detects the physiological and biochemical signals that occur during the behavior, and broadcasts the physiological and biochemical signals to the outside; the physiological signals are selected from heart rate, electrocardiogram, HRV, skin impedance, body temperature, blood oxygen, and blood pressure, and the biochemical signals are selected from blood glucose concentration, lactate concentration, cortisol concentration, alcohol concentration, and drug concentration.

5. The system according to claims 1 and 4, further includes a wireless camera or recording device in the chest-worn device, or an additional wireless camera or recording device, at least one of which can be triggered by the motion or position judgment of the IMU in the wearable device, or by the user pressing a button on the chest-worn device to take a photo, or by Bluetooth triggering from the outside, or by the Bluetooth communication RSSI strength increasing relative to the proximity of the physiological wristband and the chest-worn device as the dominant hand of the user holding an object near their mouth, thereby triggering the wireless camera in the chest-worn device to take a photo.

6. A system as claimed in claim 5, further comprising a wearable camera that is used to record the user's eating, drinking, and smoking behaviors; the camera is used to effectively record each instance of the user's eating behavior and its contents, especially for users who eat spontaneously and irregularly throughout the day.

7. A system as claimed in claims 1 and 4, further comprising a router, gateway, and server in the IoT system; the router receives broadcast packets from the chest-worn device and the detection bracelet and upload them to the server; the server then analyzes and records the user's behavior, including the location and time of occurrence, user habits, and the correlation between physiological and biochemical signals during behavior; the system also analyzes the stability and variability of the user's daily routines and activities, as well as the variability of their behavior.

8. A system as claimed in claim 1, further utilizes Pedestrian Dead Reckoning (PDR) and a reliable location provided by furniture as the starting point when the user leaves that location; the system then utilizes a step counter and IMU to determine the user's orientation and position, and combines this information with the location's magnetic fingerprint, RSSI, latitude and longitude, and user orientation; this enables the system to calculate the user's precise location relative to the nearest piece of furniture, and recognize the user's behavior based on their interactions with that piece of furniture.

9. The system according to claim 1, wherein the packet information broadcast to the chest-worn device follows the default process as follows:
(a) Use an app to assist the user in creating a floor plan for the living space, including the positions of each piece of furniture in each area, as well as the position of a socket for installing nodes or a wall position for attaching battery-powered tags (beacons);
(b) With the indoor floor plan, the user installs nodes at the socket positions in each area or attaches tags (beacons) to the indoor walls in each area;
the user wearing the chest-worn device goes to each piece of furniture in each area and sets the geomagnetic fingerprint, RSSI fingerprint, longitude and latitude, and orientation used when using that piece of furniture.

10. The system according to claim 9, wherein a detailed procedure for broadcasting packet information to the chest-worn device is as follows:
Step (1): the user wears the chest-worn device and carries a mobile device to a room in a venue;
Step (2): the user stands in front of a piece of furniture or uses the furniture and remains stationary; the user then activates the setting mode on the mobile app; the app notifies the chest-worn device to execute the broadcast of the setting mode information to the app. The chest-worn device broadcasts the following information to the app: (a). the RSSI of the positioning broadcast packet emitted by the nodes or tags in the room at that time, (b). the orientation of the chest-worn device, (c). the magnetic field strength of the location where the chest-worn device is located; after receiving at least 20 packets of this information from the chest-worn device, the app calculates the average or fingerprint of the RSSI, orientation, and magnetic field strength, and adds the longitude and latitude of the furniture's location to set it as a fingerprint of the furniture in that room;
Step (3): after 5 seconds, the app notifies the user that the calibration is complete, and the user moves on to the next piece of furniture;
Step (4): the user repeats Steps (2) and (3) until all pieces of furniture have been calibrated, and their fingerprints are obtained;
Step (5): the app connects to the node or tag and writes the fingerprints obtained in Step (4);
Step (6): the user moves to another room in the venue and repeats Steps (2) to (5) until all rooms in the venue are completed.

11. The system as claimed in claim 1, further comprising a table-mounted camera positioned within a range of 80-150 cm above the table, specifically within the dining table area; whenever a user stays within the dining table area, regardless of whether they are standing or sitting, a device worn on their chest sends the table's location information to the cloud; the cloud then pushes a request for the camera to take a photo and upload it to the cloud; the restaurant's behavior is then analyzed in conjunction with the table-mounted camera to determine the type of behavior, including eating, taking medicine, drinking water, or having a snack.

12. The system as claimed in claim 1, further comprising at least one fixed or mobile intelligent speaker, such as Zenbo, Temi, Amazon Astro, or robotic dogs; the server or cloud performs analysis and computation on the data collected from the device worn on the chest, physiological wristbands, and even environmental sensors, to accurately identify various behaviors and classify them into good or bad habits based on historical records; behavioral change interventions are selectively implemented, and users are actively reminded by intelligent speakers or passively answering their queries, as well as continuously recognizing various behaviors to confirm whether the behavior has improved or not.
